(19) United States
(12) Patent Application Publication
(10) Pub. No.: US 2025/0253779 A1
(43) Pub. Date: Aug. 7, 2025

(54) RADIATION TOLERANT HIGH VOLTAGE AC TO LOW VOLTAGE DC POWER CONVERSION SYSTEM

(71) Applicant: Hamilton Sundstrand Corporation, Charlotte, NC (US)

(72) Inventors: Baljit Riar, Rocky Hill, CT (US); Suman Dwari, Vernon, CT (US); Parikshith Channegowda, Marlborough, CT (US); Michael Anthony Futrell, Rockford, IL (US)

(21) Appl. No.: 18/433,825

(22) Filed: Feb. 6, 2024

(51) Int. Cl. H02M 7/04; H02J 3/38; H02M 7/00

(52) U.S. Cl. CPC H02M 7/043; H02J 3/38; H02M 7/003

(57) ABSTRACT

Embodiments of the disclosure provide an electric power distribution (EPD) system that includes a first conversion module electronically connected between a voltage source and a bus. The first conversion module includes a transformer system electronically connected to a first converter circuit having a first maximum voltage rating. The voltage source provides a voltage source output, and the first maximum voltage rating is less than the voltage source output.

### BACKGROUND

The present disclosure relates in general to electrical power generation and delivery systems. More specifically, the present disclosure relates to a radiation tolerant power conversion system operable to convert high voltage alternating current (AC) to low voltage direct current (DC).

Electrical power generation and delivery systems are designed to generate, transmit, and distribute electrical energy to loads. Electrical power generation and delivery systems include a variety of equipment, such as electrical generators, electrical motors, power transformers, conductive cables for electrical distribution and/or communication (referred to herein generally as “transmission lines”), circuit breakers, switches, buses, transmission and/or feeder lines, voltage regulators, capacitor banks, and the like. Such equipment may be monitored, controlled, automated, and/or protected using intelligent electronic devices (IEDs) that receive electric power system information from the equipment, make decisions based on the information, and provide monitoring, control, protection, and/or automation outputs to the equipment.

A microgrid is a self-sufficient energy system that serves a discrete geographic footprint, such as a college campus, hospital complex, business center or neighborhood. Within microgrids are one or more kinds of distributed energy (solar panels, wind turbines, combined heat and power, generators) that produce its power. In addition, many newer microgrids contain energy storage, typically from batteries. Some also now have electric vehicle charging stations. Interconnected to nearby buildings, the microgrid provides electricity and possibly heat and cooling for its customers, delivered via sophisticated software and control systems.

NASA's moon-to-mars strategy and Artemis program are to create an interoperable global lunar utilization infrastructure where U.S. industry and international partners can maintain continuous robotic and human presence on the lunar surface for a robust lunar economy without NASA as the sole user, all while accomplishing science objectives and testing for Moon and beyond e.g., Mars. Work will be performed to develop an incremental lunar power generation and distribution system that is evolvable to support continuous robotic/human operation and is capable of scaling to global power utilization and industrial power levels.

The reliability of a lunar surface power grid hinges on the reliability of power converters that can process high voltages (AC or DC) (e.g., 3 KV AC at 1000 HZ) needed to transmit power over long distances in a harsh lunar environment where lunar radiation can interfere with components designed to operate in earth's atmosphere. The current state-of-the-art for converters does not provide good and reliable high voltage components with radiation tolerance.

### BRIEF DESCRIPTION

Disclosed is an electric power distribution (EPD) system that includes a first conversion module electronically connected between a voltage source and a bus. The first conversion module includes a transformer system electronically connected to a first converter circuit having a first maximum voltage rating. The voltage source provides a voltage source output, and the first maximum voltage rating is less than the voltage source output.

In addition to any one or more of the features described herein, the transformer system is configured to step the voltage source output down to a first stepped-down voltage source output.

In addition to any one or more of the features described herein, the first stepped-down voltage source output is provided as an input to the first converter circuit.

In addition to any one or more of the features described herein, the first stepped-down voltage source output provided as the input to the first converter circuit is less than or equal to the first maximum voltage rating.

In addition to any one or more of the features described herein, the first stepped-down voltage source includes a first voltage format. The first converter circuit converts the first stepped-down voltage source to a first converter circuit output voltage having a second voltage format. The first converter circuit places the first converter circuit output voltage having the second voltage format on the bus.

In addition to any one or more of the features described herein, the first converter circuit includes one or more first radiation-hardened switching elements.

In addition to any one or more of the features described herein, the EPD system further includes a second conversion module electronically connected between the voltage source and the bus.

In addition to any one or more of the features described herein, the second conversion module includes the transformer system electronically connected to a second converter circuit having a second maximum voltage rating. The second maximum voltage rating is less than the voltage source output.

In addition to any one or more of the features described herein, the transformer system is further configured to step the voltage source output down to a second stepped-down voltage source output. The second stepped-down voltage source output is provided as an input to the second converter circuit. The second stepped-down voltage source output provided as the input to the second converter circuit is less than or equal to the second maximum voltage rating. The second stepped-down voltage source includes the first voltage format. The second converter circuit converts the second stepped-down voltage source to a second converter circuit output voltage having the second voltage format. The second converter circuit places the second converter circuit output voltage having the second voltage format on the bus. The second converter circuit includes one or more second radiation-hardened switching elements.

In addition to any one or more of the features described herein, the first voltage format includes alternating current (AC), and the second voltage format includes direct current (DC). The bus includes a DC bus. The EPD system further includes a converter controller electronically coupled to the first converter circuit and the second converter circuit. The converter controller controls how the first converter circuit places the first converter circuit output voltage having the second voltage format on the bus. The converter controller further controls how the second converter circuit places the second converter circuit output voltage having the second voltage format on the bus.

In addition to any one or more of the features described herein, the first conversion module is electronically connected in parallel with the second conversion module.

In addition to any one or more of the features described herein, the first conversion module is electronically connected in series with the second conversion module.

Further disclosed is a method of making an EPD system that includes performing fabrication operations that include forming a first conversion module electronically connected between a voltage source and a bus. The first conversion module includes a transformer system electronically connected to a first converter circuit having a first maximum voltage rating. The voltage source provides a voltage source output, and the first maximum voltage rating is less than the voltage source output.

In addition to any one or more of the features described herein, the transformer system is configured to step the voltage source output down to a first stepped-down voltage source output.

In addition to any one or more of the features described herein, the first stepped-down voltage source output is provided as an input to the first converter circuit.

In addition to any one or more of the features described herein, the first stepped-down voltage source output provided as the input to the first converter circuit is less than or equal to the first maximum voltage rating.

In addition to any one or more of the features described herein, the first stepped-down voltage source includes a first voltage format. The first converter circuit converts the first stepped-down voltage source to a first converter circuit output voltage having a second voltage format. The first converter circuit places the first converter circuit output voltage having the second voltage format on the bus.

In addition to any one or more of the features described herein, the first converter circuit includes one or more first radiation-hardened switching elements.

In addition to any one or more of the features described herein, the fabrication operations further include forming a second conversion module electronically connected between the voltage source and the bus.

In addition to any one or more of the features described herein, the second conversion module includes the transformer system electronically connected to a second converter circuit having a second maximum voltage rating. The second maximum voltage rating is less than the voltage source output.

In addition to any one or more of the features described herein, the transformer system is further configured to step the voltage source output down to a second stepped-down voltage source output. The second stepped-down voltage source output is provided as an input to the second converter circuit. The second stepped-down voltage source output provided as the input to the second converter circuit is less than or equal to the second maximum voltage rating. The second stepped-down voltage source includes the first voltage format. The second converter circuit converts the second stepped-down voltage source to a second converter circuit output voltage having the second voltage format. The second converter circuit places the second converter circuit output voltage having the second voltage format on the bus. The second converter circuit includes one or more second radiation-hardened switching elements.

In addition to any one or more of the features described herein, the first voltage format includes alternating current (AC), and the second voltage format includes direct current (DC). The bus includes a DC bus. The fabrication operations further include forming a converter controller electronically coupled to the first converter circuit and the second converter circuit. The converter controller controls how the first converter circuit places the first converter circuit output voltage having the second voltage format on the bus. The converter controller further controls how the second converter circuit places the second converter circuit output voltage having the second voltage format on the bus.

In addition to any one or more of the features described herein, the first conversion module is electronically connected in parallel with the second conversion module.

In addition to any one or more of the features described herein, the first conversion module is electronically connected in series with the second conversion module.

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE DRAWINGS

For a more complete understanding of this disclosure, reference is now made to the following brief description, taken in connection with the accompanying drawings and detailed description, wherein like reference numerals represent like parts:

FIG. 1 is a simplified block diagram illustrating a system in accordance with embodiments of the disclosure;

FIG. 2 is a simplified block diagram illustrating another system in accordance with embodiments of the disclosure;

FIG. 3 is a simplified block diagram illustrating another system in accordance with embodiments of the disclosure;

FIG. 4 is a simplified block diagram illustrating another system in accordance with embodiments of the disclosure;

FIG. 5 is a simplified block diagram illustrating another system in accordance with embodiments of the disclosure;

FIG. 6 is a simplified block diagram illustrating another system in accordance with embodiments of the disclosure;

FIG. 7 is a simplified block diagram illustrating another system in accordance with embodiments of the disclosure;

FIG. 8 is a simplified block diagram illustrating another system in accordance with embodiments of the disclosure;

FIG. 9 is a simplified block diagram illustrating another system in accordance with embodiments of the disclosure;

FIG. 10 is a simplified block diagram illustrating another system in accordance with embodiments of the disclosure;

FIG. 11 is a simplified diagram illustrating a control methodology in accordance with embodiments of the disclosure; and

FIG. 12 depicts a computing system that can be utilized to implement aspects of the disclosure.

In the accompanying figures and following detailed description of the disclosed embodiments, the various elements illustrated in the figures are provided with three digit reference numbers. In some instances, the leftmost digits of each reference number corresponds to the figure in which its element is first illustrated.

### DETAILED DESCRIPTION

A detailed description of one or more embodiments of the disclosed apparatus and method are presented herein by way of exemplification and not limitation with reference to the Figures.

Embodiments of the disclosure provide a radiation tolerant power conversion system operable to convert high voltage alternating current (AC) to low voltage direct current (DC). Radiation hardened converters, in general, have a limited voltage range of about 300V that is set by the voltage rating of the radiation-hardened semiconductor devices used to form the switching circuitry of the converter. Embodiments of the disclosure address this shortcoming by providing a radiation-hardened converter that scales with the voltage/power/current by the addition of more modules in series and/or in parallel; hybridizes an AC transformer with a rectifying unit; forms an AC grid or active power factor correction; and autonomously regulates the DC bus voltage based on a predetermined look up table (LUT) mapping state of various sources and loads connected to the same DC bus.

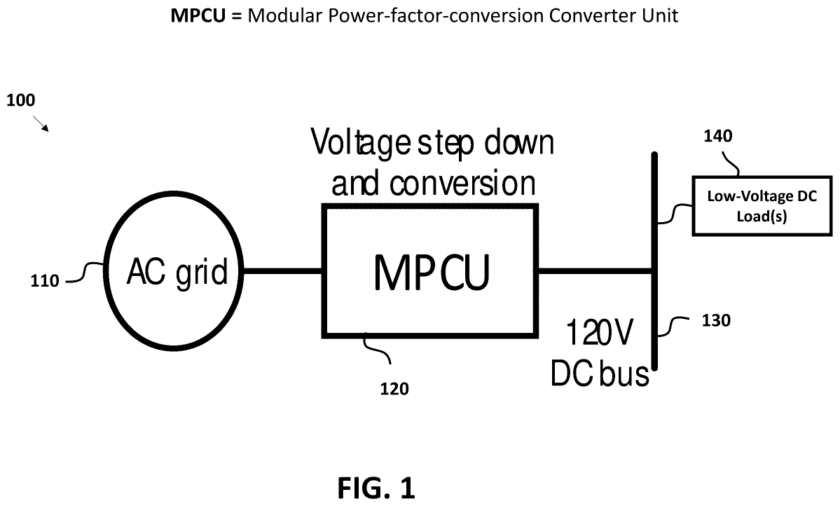

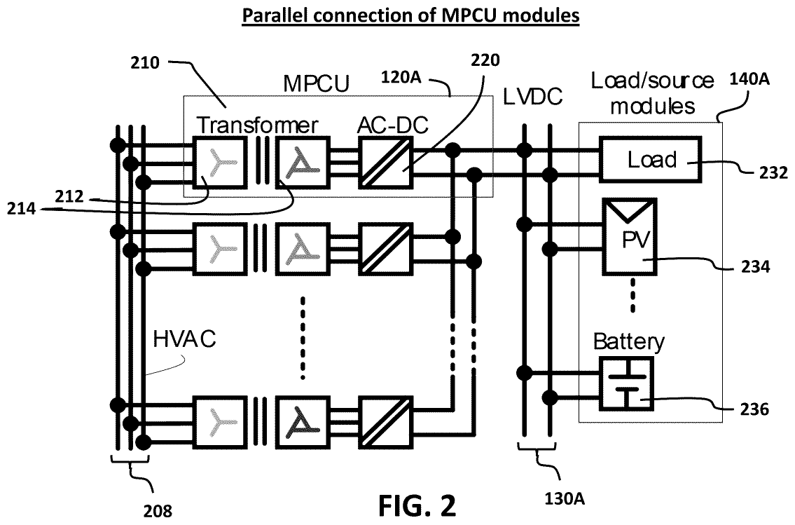

FIG. 1 is a simplified block diagram illustrating a system 100 in accordance with embodiments of the disclosure. The system 100 includes modular power-factor-conversion converter unit (MPCU) 120 electronically coupled between an AC grid 110 and a DC bus 130. A variety of types of low-voltage DC loads 140 couple to the DC bus 130 to access power therefrom. The MPCU 120 is operable to perform voltage step down and conversion operations embodying aspects of the present disclosure. Additional details of how the MPCU 120 can be implemented and controlled are depicted in FIGS. 2-12 and described in greater detail subsequently herein.

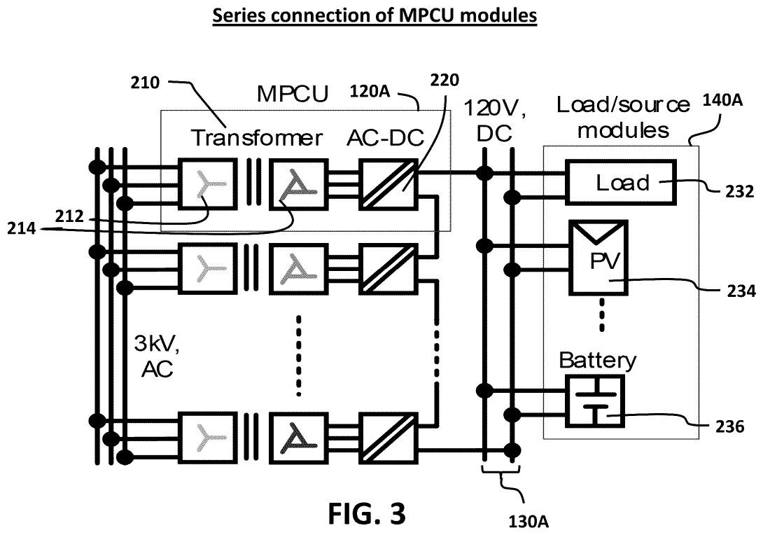

FIG. 2 is a simplified block diagram illustrating a non-limiting example of how the MPCU 120 (shown in FIG. 1) can be implemented as MPCU 120A having a transformer 210 and AC/DC converters 220, configured and arranged as shown. The transformer 210 includes primary windings 212 and secondary windings 214. In FIG. 2, the MPCU modules 120A are connected to one another in parallel. FIG. 3 is substantially the same as FIG. 2 except the MPCU modules 120A are connected to one another in series. Referring now to FIG. 2, MPCU 120A acts as an interface in between a higher voltage AC (HVAC) bus 208 and a low voltage DC (LVDC) bus 130A, such as 120V. A modular block diagram of the proposed architecture for the MPCU 120A is shown in FIG. 2 where a hybrid transformer steps down the high voltage AC (HVAC) to much lower AC voltage that is converted to DC with an AC-DC power factor correction (PFC) converter 220. In general, Power Factor Correction is a technique which uses capacitors to reduce the reactive power component of an AC circuit in order to improve its efficiency and reduce current. When dealing with direct current (DC) circuits, the power dissipated by the connected load is simply calculated as the product of the DC voltage times the DC current, that is V*I, given in watts (W). For a fixed resistive load, current is proportional to the applied voltage so the electrical power dissipated by the resistive load will be linear. But in an alternating current (AC) circuit the situation is slightly different as reactance affects the behavior of the circuit. For an AC circuit, the power dissipated in watts at any instant in time is equal to the product of the volts and amperes at that exact same instant, this is because an AC voltage (and current) is sinusoidal so changes continuously in both magnitude and direction with time at a rate determined by the source frequency. In a DC circuit the average power is simply V*I, but the average power of an AC circuit is not the same value as many AC loads have inductive elements, such as coils, windings, transformers, etc. where the current is out of phase with the voltage by some degrees resulting in the actual power dissipated in watts being less than the product of the voltage and current. This is because in circuits containing both resistance and reactance, the phase angle between them must also be taken into account.

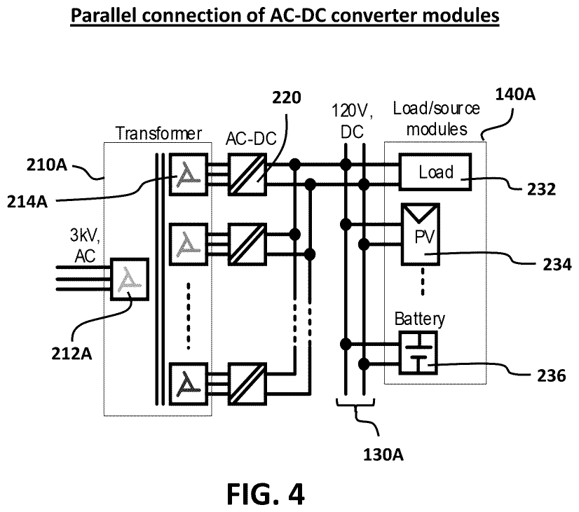

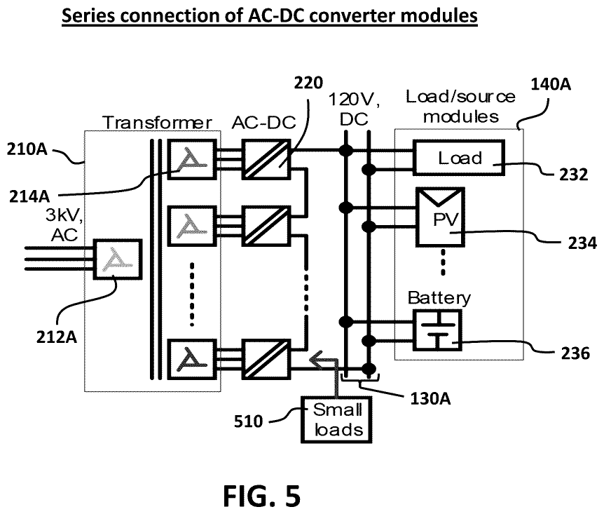

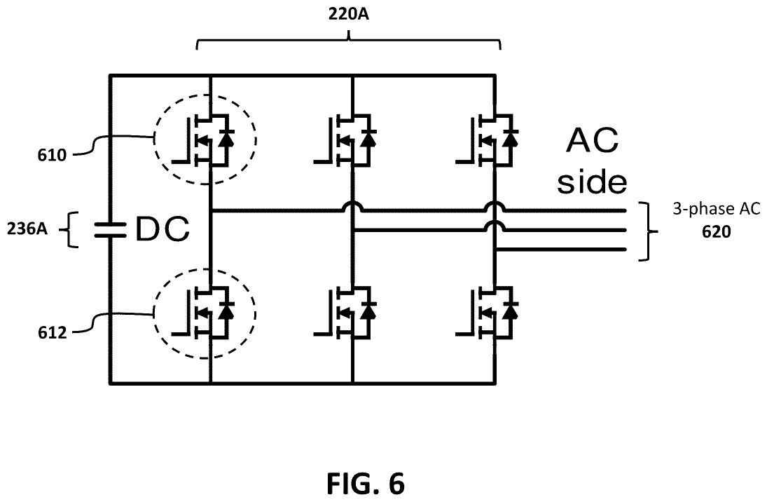

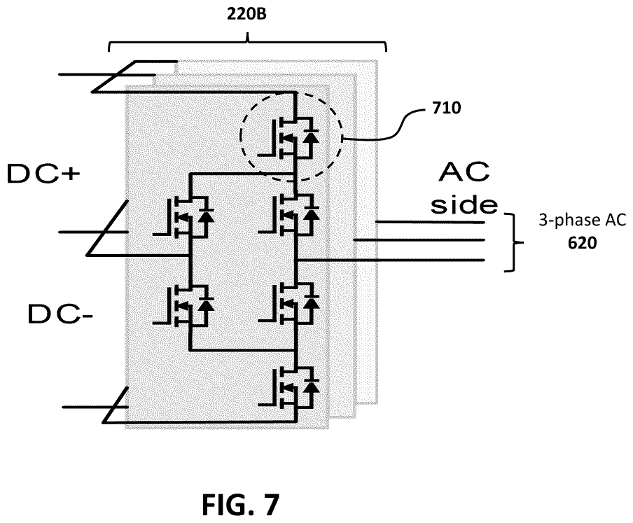

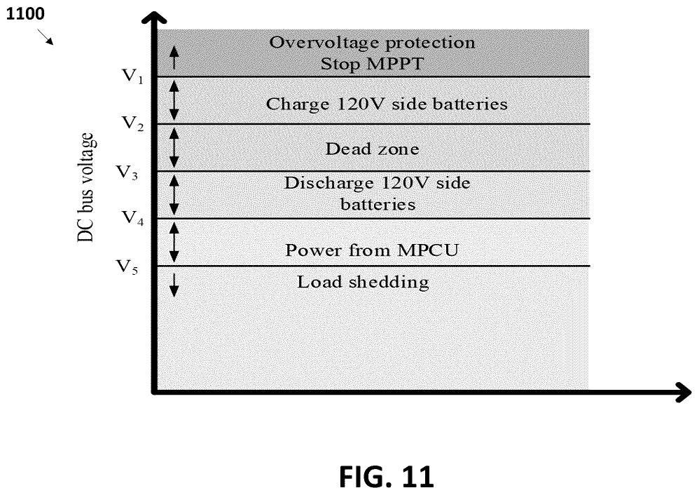

The AC-DC PFC converter 220 regulates the low voltage DC bus 130A autonomously based on the LUT 1100 (shown in FIG. 11). Multiple instances of the MPCU modules 120A are connected in parallel to form a low voltage DC bus (e.g., 120V DC bus 130A). The power rating of each converter module 120A depends on the total power demand and number of modules 120A connected in parallel. The voltage levels of the radiation-hardened semiconductor devices 610 (shown in FIG. 6), 710 (shown in FIG. 7) set the step-down voltage ratio of the transformer 210. Another variant of the architecture is shown in FIG. 3 where a series connection of the MPCU converter modules 120A is shown to form a 120V DC bus 130A. The series connection of modules 120A enables the use of even lower voltage rated devices in each module 120A for establishing a 120V DC bus 130A. Alternatively, the modules 120A with lower voltage rating can be cascaded in series to increase the de link voltage to higher than 120V if needed for the transmission of DC power. Another variant of the MPCU module architecture is shown in FIG. 4 where a multi-winding (windings 212A, 214A) multiport transformer 210A steps down the medium voltage to a much lower AC voltage for the AC-DC power factor correction (PFC) converter. A parallel connection of modules are all connected to the LVDC 130A. Alternatively, a series connection of modules is shown in FIG. 5. Some features of the MPCUs 120, 120A 210A, 220 includes: extracting power from AC grid 110 at unity power factor and acting as a rectifier while feeding power to loads 140A and establishing the 120V bus 130A. Active power-factor-correction (PFC) with the regulation of low frequency harmonics is injected by each converter into the 3 kV distribution bus, thereby improving the quality of power distribution. Each converter in essence regulates the phase angle of the current drawn from the 3 kV bus, and the phase angle in between the bus voltage and the current then determines the power factor. In the absence of the AC grid 110, a PV 234 and battery 236 connected on the DC side of the converter modules 120A supply power and supports grid forming i.e., establishing grid voltage and frequency. High step-down transformer with multi winding arrangement as well as integrated leakage inductance for performing voltage buck and boost operations of the bidirectional PFC are also provided.

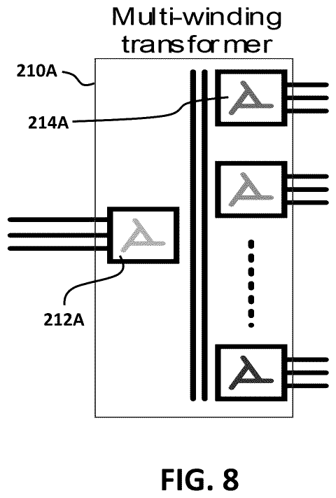

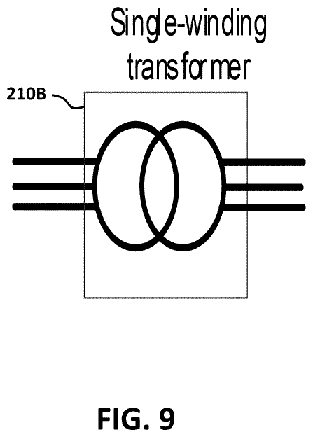

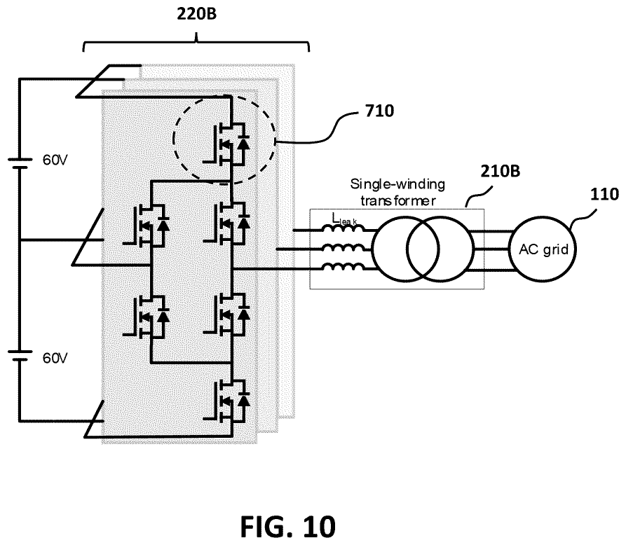

FIGS. 6 and 7 depict non-limiting example of how the AC/DC converters 220 can be implemented as AC/DC converter 220A and/or AC/DC converter 220B. The AC/DC converter 220A is a full bridge converter topology, and the AC/DC converter 220B is an NPC (neutral-point clamped) converter topology. FIGS. 8 and 9 depict non-limiting examples of transformer topologies that can be combined with the AC/DC converters 220A, 220B. The transformer 210A is multi-winding topology, and the transformer 210B is a single-winding topology. Either of the transformers 210A, 210B can be connected with any one of the AC/DC converters 220A, 220B to form an instance of the MPCU module 120. A non-limiting example of such an instance of the MPCU module 120 is shown in FIG. 10, where the AC/DC converters 220B is connected to the single-winding transformer 210B on the AC side and two 60V batteries on the DC side, thereby forming a DC bus of 120V.

Each converter module 220, 220A, 220B is designed for a low voltage operation, which is realized with the suitable AC to DC converter topology, such that the MPCU 120 is radiation hardened by design. The leakage inductance, L-leak, of the transformer can be used for PFC operation to reduce or eliminate the need for a separate inductance that is needed to be connected in series in a PFC and transformer. The voltage level of each converter module is selected to be on the lower side (e.g. <600V) such that the available high performance wide band-gap devices, such as GaN FETS, can be utilized to realize very high density and high efficiency operation while also realizing a radiation tolerant solution. For radiation tolerant design derating of the device maximum operation voltage is used as one of the potential approaches.

FIG. 11 illustrates how autonomous operation of the DC bus regulation can be achieved based on a look up table (LUT) where various voltage levels sets the operation of the units connected to the common DC bus 130A. The loads 140, 140A are shed when the DC bus voltage drops below V5. MPCU 120 (using a controller implemented, for example by computing system 1200) regulates the DC bus voltage when the voltage is in the range of [V4 V5]. With this approach MPCU 120 only provides power when the DC bus voltage falls in this voltage band. Alternatively, localized controller of MPCU 120 can be changed to draw power from the AC grid 110 when the DC bus voltage is in the range from V1 to V5, and this changes the MPCU 120 to supply power to the DC bus most of the time. The voltage band base approach illustrated in FIG. 11 significantly reduces the control complexity and communication infrastructure that is needed for multiple converters 220A, 220B to communicate with an AC or DC bus. This aspect further support plug and play, modular features of the MPCU 120.

In some embodiments of the disclosure, the autonomous operations can be performed using cognitive algorithms executing by a controller (e.g., the computing system 1200). In embodiments of the disclosure, a cognitive algorithm refers to a variety of algorithm types that generate and apply computerized models to simulate the human thought process in complex situations where the answers might be ambiguous and uncertain. A conventional cognitive algorithm includes self-learning technologies that use data mining, pattern recognition, natural language processing (NLP), and other related technologies to generate the mathematical models that make decisions (e.g., classifications, predictions, and the like) that, in effect, mimic human intelligence.

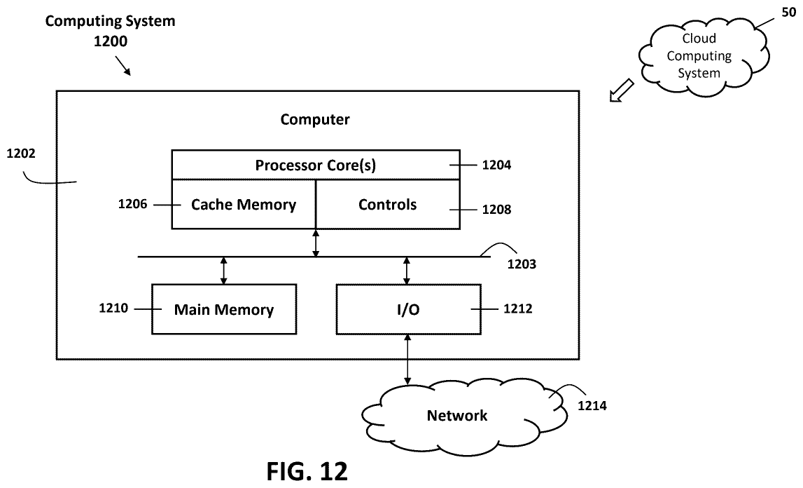

FIG. 12 illustrates an example of a computer system 1200 that can be used to implement the various processor-related operations and/or cognitive algorithms described herein. The computer system 1200 includes an exemplary computing device (“computer”) 1202 configured for performing various aspects of the content-based semantic monitoring operations described herein in accordance embodiments of the disclosure. In addition to computer 1202, exemplary computer system 1200 includes network 1214, which connects computer 1202 to additional systems (not depicted) and can include one or more wide area networks (WANs) and/or local area networks (LANs) such as the Internet, intranet(s), and/or wireless communication network(s). Computer 1202 and additional system are in communication via network 1214, e.g., to communicate data between them.

Exemplary computer 1202 includes processor cores 1204, main memory (“memory”) 1210, and input/output component(s) 1212, which are in communication via bus 1203. Processor cores 1204 includes cache memory (“cache”) 1206 and controls 1208, which include branch prediction structures and associated search, hit, detect and update logic, which will be described in more detail below. Cache 1206 can include multiple cache levels (not depicted) that are on or off-chip from processor 1204. Memory 1210 can include various data stored therein, e.g., instructions, software, routines, etc., which, e.g., can be transferred to/from cache 1206 by controls 1208 for execution by processor 1204. Input/output component(s) 1212 can include one or more components that facilitate local and/or remote input/output operations to/from computer 1202, such as a display, keyboard, modem, network adapter, etc. (not depicted).

A cloud computing system 50 is in wired or wireless electronic communication with the computer system 1200. The cloud computing system 50 can supplement, support or replace some or all of the functionality (in any combination) of the computing system 1200. Additionally, some or all of the functionality of the computer system 1200 can be implemented as a node of the cloud computing system 50A.

For the sake of brevity, conventional techniques related to making and using the disclosed embodiments may or may not be described in detail herein. In particular, various aspects of computing systems and specific computer programs to implement the various technical features described herein are well known. Accordingly, in the interest of brevity, many conventional implementation details are only mentioned briefly or are omitted entirely without providing the well-known system and/or process details.

For convenience, some of the technical operations described herein are conveyed using informal expressions. For example, a processor that has data stored in its cache memory can be described as the processor “knowing” the data. Similarly, a user sending a load-data command to a processor can be described as the user “telling” the processor to load data. It is understood that any such informal expressions in this detailed description should be read to cover, and a person skilled in the relevant art would understand such informal expressions to cover, the formal and technical description represented by the informal expression.

Many of the functional units of the systems described in this specification have been labeled as modules. Embodiments of the disclosure apply to a wide variety of module implementations. For example, a module can be implemented as a hardware circuit including custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like. Modules can also be implemented in software for execution by various types of processors. An identified module of executable code can, for instance, include one or more physical or logical blocks of computer instructions which can, for instance, be organized as an object, procedure, or function. Nevertheless, the executables of an identified module need not be physically located together, but can include disparate instructions stored in different locations which, when joined logically together, function as the module and achieve the stated purpose for the module.

The various components/modules/models of the systems illustrated herein are depicted separately for ease of illustration and explanation. In embodiments of the disclosure, the functions performed by the various components/modules/models can be distributed differently than shown without departing from the scope of the various embodiments of the disclosure describe herein unless it is specifically stated otherwise.

Aspects of the disclosure can be embodied as a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The terms “about,” “substantially,” “substantial,” “approximately,” and equivalents thereof are intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An electric power distribution (EPD) system comprising:
a first conversion module electronically connected between a voltage source and a bus;
wherein the first conversion module comprises a transformer system electronically connected to a first converter circuit having a first maximum voltage rating;
wherein the voltage source provides a voltage source output; and
wherein the first maximum voltage rating is less than the voltage source output.

2. The EPD system of claim 1, wherein the transformer system is configured to step the voltage source output down to a first stepped-down voltage source output.

3. The EPD system of claim 2, wherein the first stepped-down voltage source output is provided as an input to the first converter circuit.

4. The EPD system of claim 3, wherein the first stepped-down voltage source output provided as the input to the first converter circuit is less than or equal to the first maximum voltage rating.

5. The EPD system of claim 4, wherein:
the first stepped-down voltage source comprises a first voltage format;
the first converter circuit converts the first stepped-down voltage source to a first converter circuit output voltage having a second voltage format; and
the first converter circuit places the first converter circuit output voltage having the second voltage format on the bus.

6. The EPD system of claim 5, wherein the first converter circuit comprises one or more first radiation-hardened switching elements.

7. The EPD system of claim 6 further comprising a second conversion module electronically connected between the voltage source and the bus.

8. The EPD system of claim 7, wherein:
the second conversion module comprises the transformer system electronically connected to a second converter circuit having a second maximum voltage rating; and
the second maximum voltage rating is less than the voltage source output.

9. The EPD system of claim 8, wherein:
the transformer system is further configured to step the voltage source output down to a second stepped-down voltage source output;
the second stepped-down voltage source output is provided as an input to the second converter circuit;
the second stepped-down voltage source output provided as the input to the second converter circuit is less than or equal to the second maximum voltage rating;
the second stepped-down voltage source comprises the first voltage format;
the second converter circuit converts the second stepped-down voltage source to a second converter circuit output voltage having the second voltage format;
the second converter circuit places the second converter circuit output voltage having the second voltage format on the bus; and
the second converter circuit comprises one or more second radiation-hardened switching elements.

10. The EPD system of claim 9, wherein:
the first voltage format comprises alternating current (AC);
the second voltage format comprises direct current (DC);
the bus comprises a DC bus;
the EPD system further comprises a converter controller electronically coupled to the first converter circuit and the second converter circuit;
the converter controller controls how the first converter circuit places the first converter circuit output voltage having the second voltage format on the bus; and
the converter controller further controls how the second converter circuit places the second converter circuit output voltage having the second voltage format on the bus.

11. The EPD system of claim 9, wherein the first conversion module is electronically connected in parallel with the second conversion module.

12. The EPD system of claim 9, wherein the first conversion module is electronically connected in series with the second conversion module.

13. A method of forming an electric power distribution (EPD) system, the method comprising performing fabrication operations comprising:
forming a first conversion module electronically connected between a voltage source and a bus;
wherein the first conversion module comprises a transformer system electronically connected to a first converter circuit having a first maximum voltage rating;
wherein the voltage source provides a voltage source output; and
wherein the first maximum voltage rating is less than the voltage source output.

14. The method of claim 13, wherein:
the transformer system is configured to step the voltage source output down to a first stepped-down voltage source output;
the first stepped-down voltage source output is provided as an input to the first converter circuit; and
the first stepped-down voltage source output provided as the input to the first converter circuit is less than or equal to the first maximum voltage rating.

15. The method of claim 14, wherein:
the first stepped-down voltage source comprises a first voltage format;
the first converter circuit converts the first stepped-down voltage source to a first converter circuit output voltage having a second voltage format;
the first converter circuit places the first converter circuit output voltage having the second voltage format on the bus; and
the first converter circuit comprises one or more first radiation-hardened switching elements.

16. The method of claim 15, wherein the fabrication operations further comprise forming a second conversion module electronically connected between the voltage source and the bus.

17. The method of claim 16, wherein:
the second conversion module comprises the transformer system electronically connected to a second converter circuit having a second maximum voltage rating;
the second maximum voltage rating is less than the voltage source output;
the transformer system is further configured to step the voltage source output down to a second stepped-down voltage source output;
the second stepped-down voltage source output is provided as an input to the second converter circuit;
the second stepped-down voltage source output provided as the input to the second converter circuit is less than or equal to the second maximum voltage rating;
the second stepped-down voltage source comprises the first voltage format;
the second converter circuit converts the second stepped-down voltage source to a second converter circuit output voltage having the second voltage format;
the second converter circuit places the second converter circuit output voltage having the second voltage format on the bus; and
the second converter circuit comprises one or more second radiation-hardened switching elements.

18. The method of claim 17, wherein:
the first voltage format comprises alternating current (AC);
the second voltage format comprises direct current (DC);
the bus comprises a DC bus;
the fabrication operations further comprise providing a converter controller electronically coupled to the first converter circuit and the second converter circuit;
the converter controller controls how the first converter circuit places the first converter circuit output voltage having the second voltage format on the bus; and
the converter controller further controls how the second converter circuit places the second converter circuit output voltage having the second voltage format on the bus.

19. The method of claim 18, wherein the first conversion module is electronically connected in parallel with the second conversion module.

20. The method of claim 18, wherein the first conversion module is electronically connected in series with the second conversion module.
